(19) United States
(12) Patent Application Publication
(10) Pub. No.: US 2025/0286888 A1
(43) Pub. Date: Sep. 11, 2025

(54) System And Method For Managing Security For A Cloud Infrastructure Realm Using Cross-Domain Approval

(71) Applicant: Oracle International Corporation, Redwood Shores, CA (US)

(72) Inventors: Jeremiah David Small, Wesford, MA (US); Yavor Tashev, Issaquah, WA (US); Martin John Sleeman, Redmond, WA (US); Mohith Ramesh Pukale, Seattle, WA (US); Girish Nagaraja, Sammamish, WA (US); Ashutosh B. Pitre, Dublin, CA (US); Siddharth Sathish Shenoy, Sammamish, WA (US); Olaf Stullich, Chesterfield, VA (US); Harsh Aseeja, Kirkland, WA (US)

(73) Assignee: Oracle International Corporation, Redwood Shores, CA (US)

(21) Appl. No.: 18/595,781

(22) Filed: Mar. 5, 2024

(51) Int. Cl. H04L 9/40

(52) U.S. Cl. CPC H04L 63/10

(57) ABSTRACT

Techniques for providing dedicated or private label cloud (PLC) environments for use by tenants of a cloud infrastructure environment in accessing software products, services, or other offerings associated with the environment are disclosed. An operator, authenticated with respect to a provider identity domain, makes a request to access a resource associated with an operator tenancy without being associated with the operator identity domain. A cross-domain approval process is executed to determine whether or not to provide access to the operator.

### TECHNICAL FIELD

The present disclosure relates to systems and methods for providing dedicated and/or private label cloud (PLC) environments for use by tenants of a cloud infrastructure environment in accessing software products, services, or other offerings associated with the environment. In particular, the present disclosure relates to managing security for a PLC realm based on multiple operator types and cross-domain approvals.

### BACKGROUND

A cloud computing environment can be used to provide access to a range of complementary cloud-based components, such as software applications or services that enable organizations or enterprise customers to operate their applications and services in a highly available hosted environment.

The benefits to an organization in moving their application and service needs to a cloud environment include a reduction in the cost and complexity of designing, building, operating, and maintaining their own on-premises data center, software application framework, or other information technology infrastructure.

In a cloud environment, access policy statements define the permissions for what operators have access to what cloud resources. In particular, an access policy statement specifies which operators or groups, in a particular identity domain, have access to which cloud resources, in a particular compartment. An access policy statement typically includes the principal (the operator or group being granted access, and the identity domain to which they belong), the action (the type of access being granted, such as read, write, or execute), the resource (the specific cloud resource to which access is being granted, and the compartment to which the cloud resource belongs), and optionally the conditions under which the access is allowed. An example syntax may be as follows:
allow group <identity_domain_name>/<group_name > to <verb> <resource-type > in compartment <compartment_name > where <conditions>

A compartment represents a collection of cloud resources. Each compartment acts as a boundary for managing cloud resources within the compartment. Using compartments, cloud resources may be separated for the purposes of measuring usage and billing, access (through the use of access policies), and isolation (separating the resources for one project or business unit from another).

A compartment may have one or more child compartments. An access policy statement scoped to a particular compartment applies to cloud resources in the particular compartment and, if any, one or more child compartments. A root compartment, which has no parent compartment, may be referred to as a “tenancy.” A cloud environment may include one or more tenancies.

An identity domain represents an operator population, and its associated configurations and security settings. An identity domain is used for managing users and groups, federating and provisioning of users, and securing application integration. Each identity domain acts as a boundary for managing identities within the identity domain.

A cloud operator may desire to control access to cloud resources through the use of tools such as access policy statements, group memberships, and application accesses.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for providing a cloud infrastructure environment in accordance with an embodiment.

FIG. 2 further illustrates how a cloud infrastructure environment can be used to provide cloud-based applications or services or services in accordance with an embodiment.

FIG. 3 illustrates an example cloud infrastructure architecture in accordance with an embodiment.

FIG. 4 illustrates another example of a cloud infrastructure architecture in accordance with an embodiment.

FIG. 5 illustrates another example of a cloud infrastructure architecture in accordance with an embodiment.

FIG. 6 illustrates another example of a cloud infrastructure architecture in accordance with an embodiment.

FIG. 7 illustrates how the system can provide dedicated or private label cloud environments for use by tenants or customers of a cloud infrastructure environment in accordance with an embodiment.

FIG. 8 further illustrates the use of private label cloud realms for use by tenants or customers of a cloud infrastructure environment in accordance with an embodiment.

FIG. 9 further illustrates the use of private label cloud realms for use by tenants or customers of a cloud infrastructure environment in accordance with an embodiment.

FIG. 10 illustrates a system for providing access to software products or services in a cloud computing or other computing environment in accordance with an embodiment.

FIGS. 11-17 illustrate a system for managing security for a PLC realm based on multiple operator types and cross-domain approvals in accordance with an embodiment.

FIG. 18 illustrates an example set of operations for performing a cross-domain approval in accordance with one or more embodiments.

FIG. 19 illustrates an example set of operations for performing a cross-domain approval in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DEDICATED OR PRIVATE LABEL CLOUD ENVIRONMENTS
3. CROSS-DOMAIN APPROVAL
4. EXAMPLE EMBODIMENTS
5. VARIATIONS
6. MISCELLANEOUS; EXTENSIONS

### 1. GENERAL OVERVIEW

In an embodiment, approval workflows may be used to control group membership or application access within an identity domain. An approval workflow specifies one or more users or groups who need to approve an access request. The approval workflow may specify a sequence for obtaining approval from the users or groups, or may indicate that any sequence is acceptable. Based on the approval workflow, each approver receives a notification of the access request, and may respond with an approval or rejection. If the requisite approvals in an approval workflow are obtained, then the access granted is granted. As an example, a final approval from an approval workflow may grant an operator membership in a particular group. Where an access policy statement exists granting the particular group access to a particular cloud resource, access to the particular cloud resource by the operator will be granted. Approval workflows often help to ensure that access rights are granted based on the principle of least privilege, meaning users receive only the permissions necessary to perform their job functions.

In an embodiment, a cloud environment may include multiple identity domains. An operator requesting access to certain cloud resources may require approval from users within a different identity domain. In some embodiments, the access request may require approval from users within the requester's identity domain and within one or more additional identity domains. An approval workflow that involves obtaining approval from users within a particular identity domain may be referred to here as an approval workflow that is “with respect to” the particular identity domain, or “for” the particular identity domain. An approval workflow that involves obtaining approval from users within an identity domain different than that of the requester may be referred to herein as a “cross-domain approval workflow.” The terms “approval workflow” and “approval process” are used interchangeably herein.

In an embodiment, in a cross-domain approval workflow, the requester is within a first identity domain, and approval is required from users within a second identity domain. Sensitive information, such as personally identifiable information (PII) of the requester and/or approver(s), is not necessarily transmitted to across the two different identity domains. When determining whether to approve the request, users within the second identity domain may rely on (a) authentication of the requester within the first identity domain, and/or (b) a final approval obtained through an approval workflow with respect to the first identity domain for the request.

One or more embodiments described in this Specification and/or recited in the claims may not be included in this General Overview section.

### 2. DEDICATED OR PRIVATE LABEL CLOUD ENVIRONMENTS

One or more embodiments provide features associated with dedicated or private label cloud (PLC) environments for use by tenants of a cloud infrastructure environment in accessing software products, services, or other offerings associated with the environment.

A cloud computing or cloud infrastructure environment can be used to provide access to a range of complementary cloud-based components, such as software applications or services, that enable organizations or enterprise customers to operate their applications and services in a highly available hosted environment.

The benefits to an organization in moving its application and service needs to a cloud infrastructure environment include a reduction in the cost and complexity of designing, building, operating, and maintaining their own on-premises data center, software application framework, or other information technology infrastructure.

### Cloud Infrastructure Environments

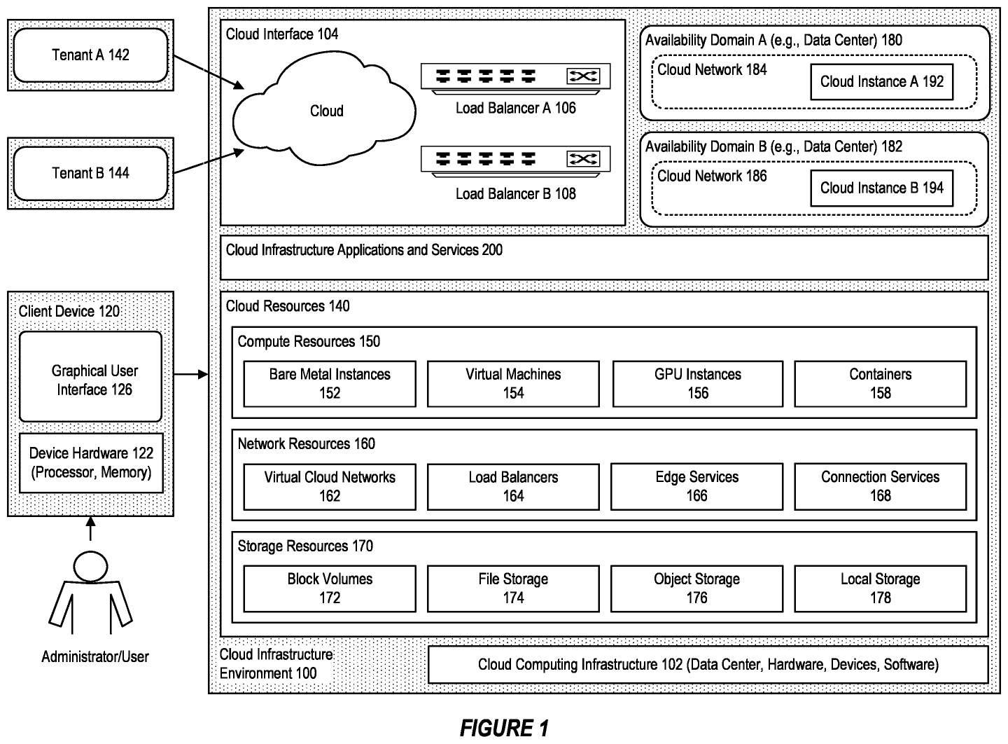

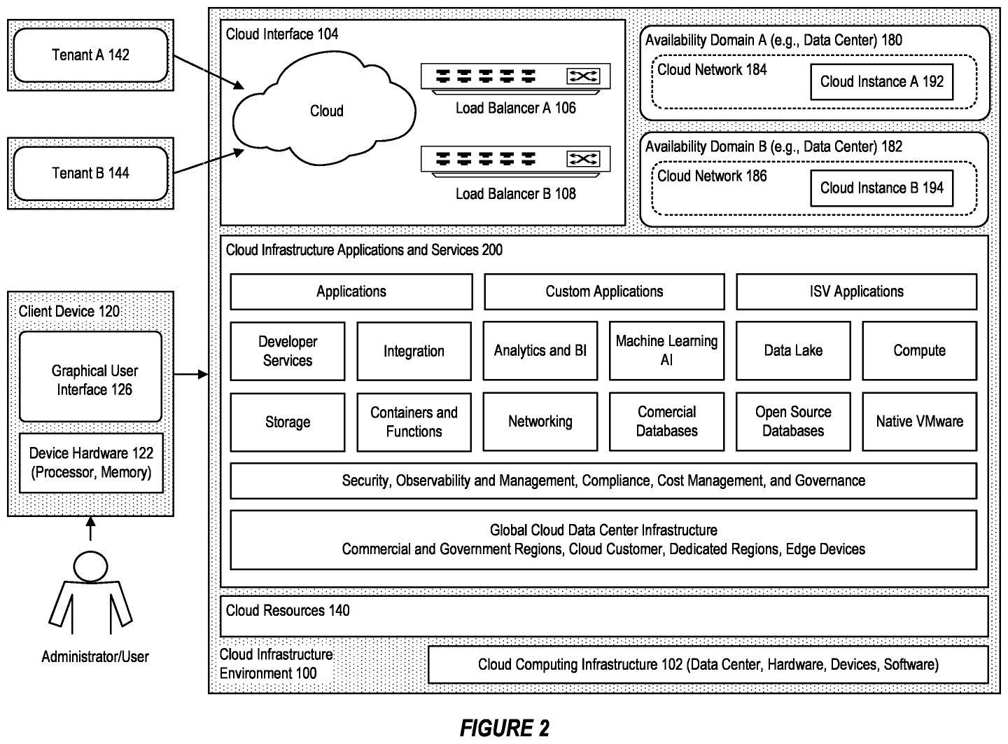

FIGS. 1 and 2 illustrate a system for providing a cloud infrastructure environment in accordance with an embodiment.

In accordance with an embodiment, the components and processes illustrated in FIG. 1, and as further described herein regarding various embodiments, can be provided as software or program code executable by a computer system or other type of processing device, for example, a cloud computing system.

The illustrated example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers A 106, B 108. Cloud interface 102 includes user interfaces and APIs provided by a cloud services provider for interacting with its cloud services. This includes tools and platforms that allow users and administrators to manage, configure, and monitor cloud resources and services. Cloud interface 102 may include a console, such as a web-based user interface that provides a visual way to interact with and manage cloud resources. Through the console, users may, for example, create, configure, and monitor cloud services like compute instances, databases, storage, and networking components. Cloud interface 102 may also include a command line interface for users who prefer to work with the cloud infrastructure using command-line tools. The CLI allows for scripting and automation of cloud management tasks in an embodiment.

In accordance with an embodiment, load balancer A 106 and load balancer B 108 are services that distribute incoming network traffic across multiple servers, instances, or other resources to ensure that no single resource bears too much demand. By spreading the requests evenly across the resources, load balancers enhance the responsiveness and availability of resources such as applications, websites, or databases. Load balancer A 106 and load balancer B 108 may be either public load balancers that are accessible from the Internet and used for distributing external traffic, or private load balancers that are used within a virtual cloud network (VCN) and are not accessible from the public Internet (and are therefore ideal for internal traffic distribution). In an embodiment, load balancer A 106 and load balancer B 108 are designed for high availability and fault tolerance and are implemented in a redundant configuration across multiple availability domains or fault domains.

In accordance with an embodiment, the cloud infrastructure environment supports the use of availability domains, such as availability domain A 180 and availability domain B 182, that enable customers to create and access cloud networks 184, 186, and run cloud instances A 192, B 194. In an embodiment, availability A 180 and availability domain B 182 may represent a data center, or a set of data centers located within a region. These availability domains may be isolated from each other, meaning that they may not share the same physical infrastructure such as power or cooling systems. This design provides a high degree of failure independence and robustness. In an embodiment, a fault domain may provide additional protection and resiliency within a single availability domain by grouping hardware and infrastructure within an availability domain that is isolated from other fault domains. This isolation may be in terms of electricity, cooling, and other potential sources of failure.

In accordance with an embodiment, a tenancy (a container for resources used by a tenant) can be created for each cloud tenant/customer, for example, tenant A 142, B 144, that provides a secure and isolated partition within the cloud infrastructure environment where the customer can create, organize, and administer their cloud resources. A cloud tenant/customer can access an availability domain and a cloud network to access each of their cloud instances. A tenancy in is isolated from other tenancies, ensuring that each customer's data and resources are secure and inaccessible to others. Within a tenancy, customers can create, manage, and organize a wide range of cloud resources, including compute instances, storage volumes, and networks. In Identity and Access Management (IAM) service enables the management of users, groups, and policies within a tenancy. Through IAM, customers can control who has access to their resources and what actions they can perform. The tenancy is also the level where billing and subscription management are handled. Usage and costs associated with the resources within a tenancy are tracked and billed collectively under that tenancy. Each tenancy may be associated with specific service limits and quotas for various resources. These limits may be used to help manage capacity and facilitate resource distribution across each tenant.

In accordance with an embodiment, a computing device, such as a client device 120 having a device hardware 122 (e.g., processor, memory) and graphical user interface 126, can enable an administrator or other user to communicate with the cloud infrastructure environment via a network, such as a wide area network, a local area network, or the Internet, to create or update cloud services.

In accordance with an embodiment, the cloud infrastructure environment provides access to shared cloud resources 140 via, for example, a compute resources layer 150, a network resources layer 160, and/or a storage resources layer 170. Customers can launch cloud instances as needed to meet compute and application requirements. After a customer provisions and launches a cloud instance, the provisioned cloud instance can be accessed from a client device such as client device 120.

In accordance with an embodiment, compute resources 150 can comprise resources, such as bare metal cloud instances 152, virtual machines 154, graphical processing unit (GPU) compute cloud instances 156, and/or containers 158. A bare metal instance represents a physical server with dedicated hardware that is fully allocated to a single tenant. A bare metal instance provides direct access to the server's processor, memory, storage, and other hardware resources. A virtual machine (VM) is a software emulation of a physical computer that runs an operating system and applications like a physical computer. VMs allow multiple operating systems to run on a single physical machine or across multiple machines. A hypervisor layer resides between the hardware and the virtual machines, allocating physical resources (like CPU, memory, and storage) to each VM. In an embodiment, GPU compute cloud instances provide GPUs along with traditional CPU resources. These instances are designed for tasks that require significant parallel processing power, making them ideal for applications like machine learning, scientific computing, 3D rendering, and video processing. In an embodiment, Containers 158 use a method of virtualization that allows for the running of multiple isolated applications on a single control host, virtualizing the operating system. Each container shares the host system's kernel but runs in an isolated user space, making containers lightweight and efficient.

The components of the compute resources 150 can be used to provision and manage bare metal compute cloud instances or provision cloud instances as needed to deploy and run applications, as in an on-premises data center. For example, in accordance with an embodiment, the cloud infrastructure environment can provide control of physical host (bare metal) machines within the compute resources layer that run as compute cloud instances directly on bare metal servers without a hypervisor.

In accordance with an embodiment, the cloud infrastructure environment can also provide control of virtual machines within the compute resources layer that can be launched, for example, from an image, wherein the types and quantities of resources available to a virtual machine cloud instance can be determined, for example, based upon the image that the virtual machine was launched from.

In accordance with an embodiment, the network resources layer can comprise several network-related resources, such as virtual cloud networks (VCNs) 162, load balancers 164, edge services 166, and/or connection services 168. In an embodiment, a virtual cloud network (VCN) is a customizable and private network in a cloud environment. A VCN provides a virtual version of a traditional network, including subnets, route tables, and gateways. It allows users to set up their cloud-based network architecture according to their requirements. In an embodiment, edge services 166 include services and technologies designed to bring computation, data storage, and networking capabilities closer to the location where they are needed. Edge services 166 may be used to optimize traffic, reduce latency, or provide other advantages.

In accordance with an embodiment, the storage resources layer can comprise several resources, such as data/block volumes 172, file storage 174, object storage 176, and/or local storage 178. Data/block volumes 172 provide unformatted block-level storage that can be used to create file systems that host databases or for other purposes requiring unformatted storage. File storage 174 provides a file system in an embodiment and may offer shared file systems that multiple instances can access concurrently using standard file storage protocols. Object storage 176 manages data as objects within storage buckets. Objects have certain attributes that may include data, metadata, and a unique identifier. Local storage 178 refers to storage devices that are physically attached to the host computer.

As illustrated in FIG. 2, in accordance with an embodiment, the cloud infrastructure environment can include a range of complementary cloud-based components, such as cloud infrastructure applications and services 200, that enable organizations or enterprise customers to operate their applications and services in a highly available hosted environment.

In accordance with an embodiment, a self-contained cloud region can be provided as a complete, e.g., Oracle Cloud Infrastructure (OCI), dedicated region within an organization's data center that offers the data center operator the agility, scalability, and economics of an e.g., OCI public cloud, while retaining full control of their data and applications to meet security, regulatory, or data residency requirements.

For example, in accordance with an embodiment, such an environment can include racks physically and logically managed by a cloud infrastructure provider (e.g., Oracle), customer's racks, access for cloud operations personnel for setup and hardware support, customer's data center power and cooling, customer's floor space, an area for customer's data center personnel, and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's (e.g., Oracle's) public cloud regions, for example, ERP, Financials, HCM, and SCM. A customer can seamlessly lift and shift legacy workloads using the cloud infrastructure provider's services (e.g., bare metal compute, VMs, and GPUs), database services (e.g., Oracle Autonomous Database), or container-based services (e.g., Oracle Container Engine for Kubernetes).

In accordance with an embodiment, a cloud infrastructure environment can operate according to an infrastructure-as-a-service (IaaS) model that enables the environment to provide virtualized computing resources over a public network (e.g., the Internet)

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components; example services include billing software, monitoring software, logging software, load balancing software, or clustering software. Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the operator can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not, be a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries or daemons). This is often managed by the cloud infrastructure provider below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like).

In accordance with an embodiment, IaaS provisioning may refer to acquiring computers or virtual hosts for use and installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on others, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various geographic locations). However, in some examples, the infrastructure where the code will be deployed requires provisioning. In some instances, the provisioning can be done manually, a provisioning tool may be utilized to provision the resources, and/or deployment tools may be utilized to deploy the code once the infrastructure is provisioned.

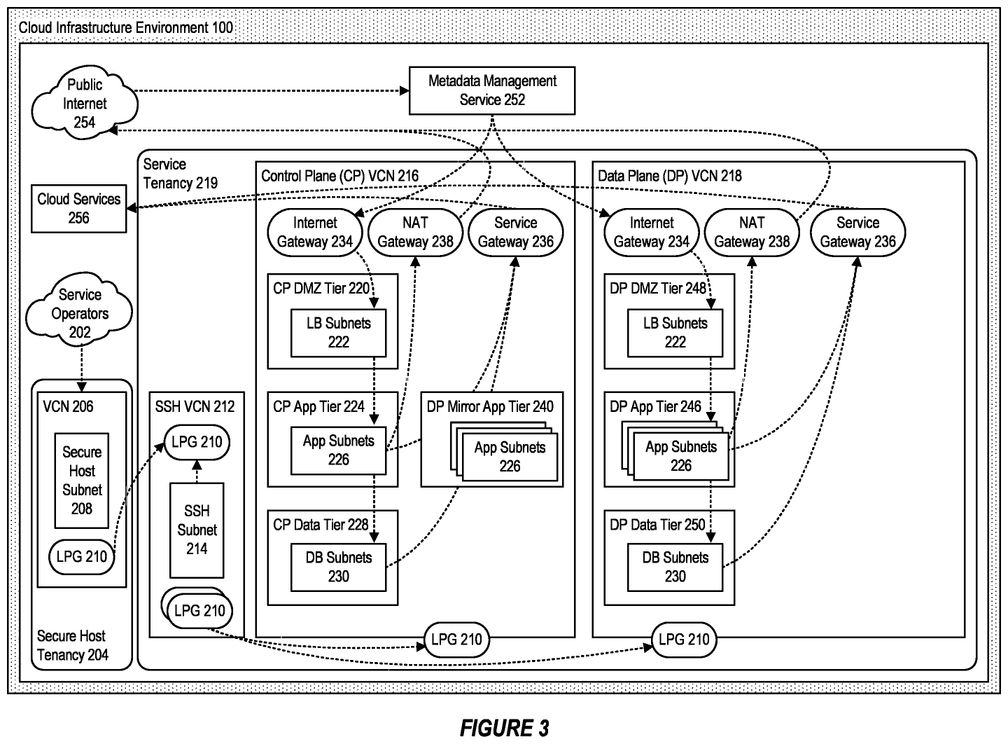

FIG. 3 illustrates an example cloud infrastructure architecture in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices that may be portable handheld devices (e.g., a telephone, a computing tablet, a personal digital assistant (PDA)) or wearable devices (e.g., a head mounted display), running software such as Microsoft Windows, and/or a variety of mobile operating systems, such as iOS, Android, and the like, and being Internet, e-mail, short message service (SMS), or other communication protocol enabled. Alternatively, the client computing devices can be general purpose personal computers including, for example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems such as Chrome OS. Additionally, or alternatively, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnets 222, a control plane app tier 224 that can include app subnets 226, and a control plane data tier 228 that can include database (DB) subnets 230 (e.g., frontend DB subnet(s) and/or backend DB subnet(s)). The LB subnet(s) contained in the control plane DMZ tier can be communicatively coupled to the app subnet(s) contained in the control plane app tier and to an Internet gateway 234 that can be contained in the control plane VCN. The app subnet(s) can be communicatively coupled to the DB subnet(s) contained in the control plane data tier, a service gateway 236, and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier, a data plane DMZ tier, and a data plane data tier. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way; the service gateway can make API calls to cloud services, and cloud services can send requested data to the service gateway. Generally, cloud services may not initiate API calls to the service gateway.

In accordance with an embodiment, the secure host tenancy can be directly connected to the service tenancy that may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example, create, read, update, or delete (CRUD) operations through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both that may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage that may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy that may be isolated from the public Internet.

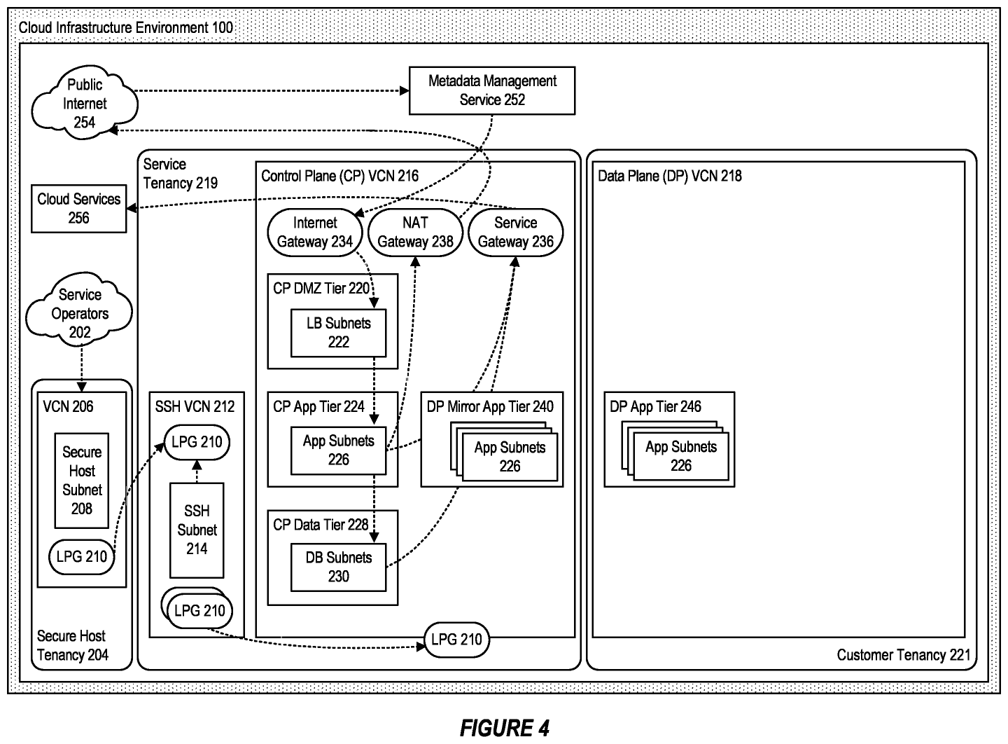

FIG. 4 illustrates another example of a cloud infrastructure architecture in accordance with an embodiment.

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources provisioned in the control plane VCN contained in the service tenancy to be deployed or otherwise used in the data plane VCN contained in the customer tenancy.

In accordance with an embodiment, a customer of the cloud infrastructure provider may have databases that are managed and operated within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but the data plane mirror app tier may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, by the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with, Deployment 1 in Region 2.

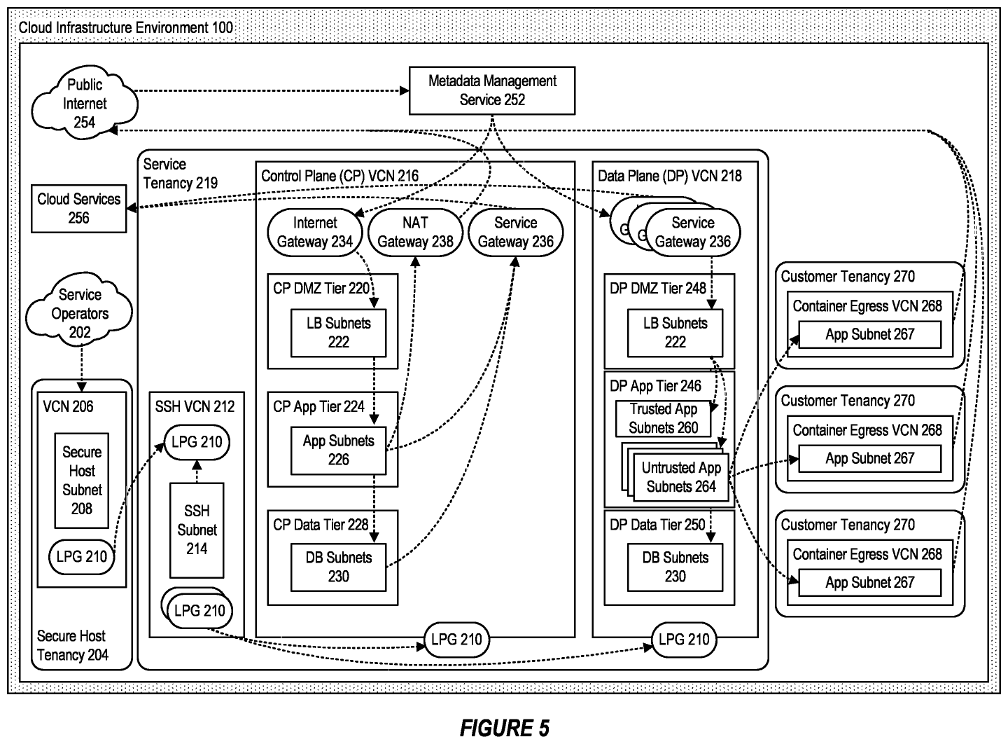

FIG. 5 illustrates another example of a cloud infrastructure architecture in accordance with an embodiment.

As illustrated in FIG. 5, in accordance with an embodiment, the trusted app subnets 260 can be communicatively coupled to the service gateway contained in the data plane VCN, the NAT gateway contained in the data plane VCN, and DB subnet(s) contained in the data plane data tier. The untrusted app subnets 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)) that may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s) and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled, or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

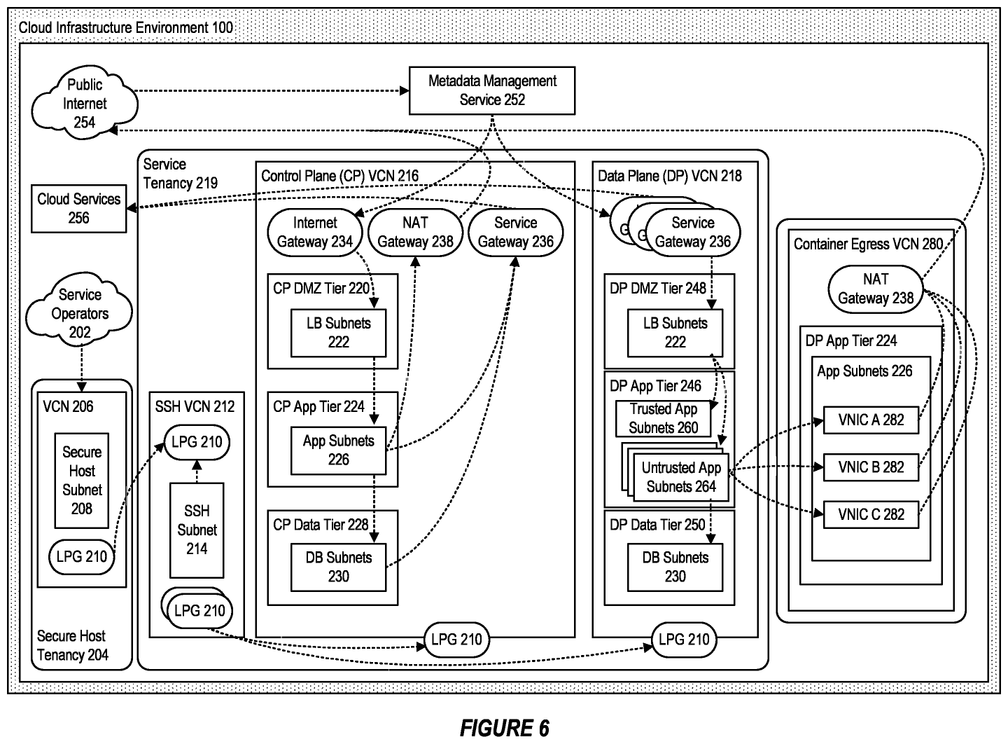

FIG. 6 illustrates another example of a cloud infrastructure architecture in accordance with an embodiment.

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container and be communicatively coupled to an app subnet that can be contained in a data plane app tier that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that request a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining that the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Private Label Cloud Environments

In accordance with an embodiment, a cloud infrastructure environment can be used to provide dedicated cloud environments, for example, as one or more private label cloud environments for use by tenants of the cloud infrastructure environment in accessing subscription-based software products, services, or other offerings associated with the cloud infrastructure environment.

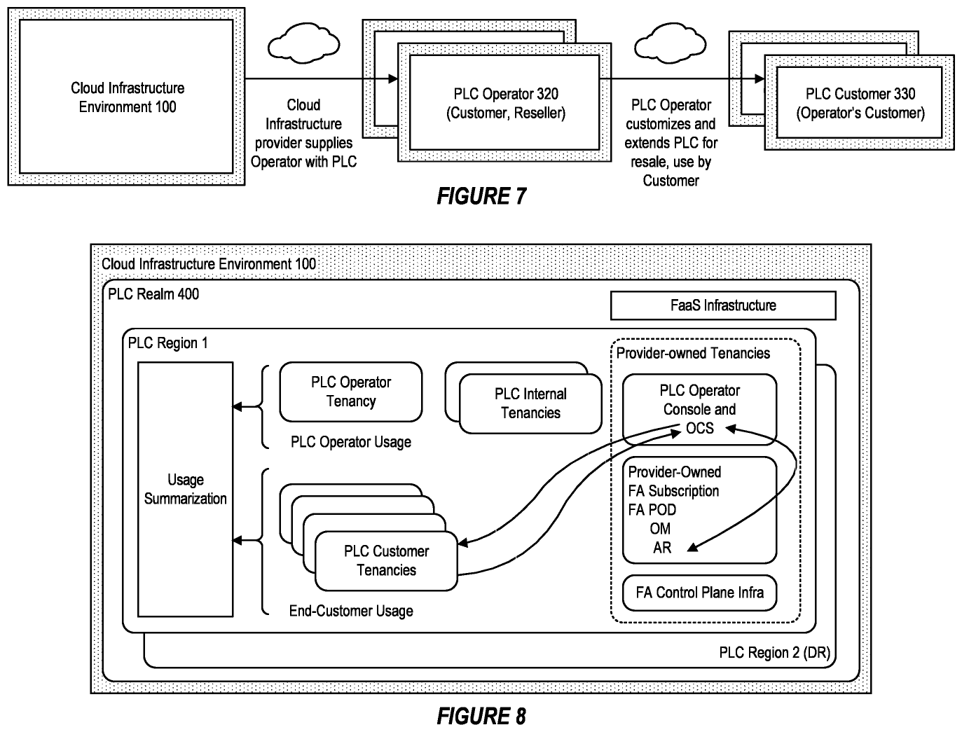

FIG. 7 illustrates how the system can provide dedicated or private label cloud environments for use by tenants or customers of a cloud infrastructure environment in accordance with an embodiment.

As illustrated in FIG. 7, in accordance with an embodiment, a cloud infrastructure provider (e.g., OCI) can supply a PLC operator 320, for example an OCI customer operating as a reseller, with one or more private label cloud (PLC) environments. The PLC operator/reseller can then customize and extend the private label cloud for use by (their) customer 330 for use in accessing subscription-based software products, services, or other offerings associated with the cloud infrastructure environment.

For purposes of illustration, examples of such subscription-based products, services, or other offerings may include various Oracle Cloud Infrastructure software products, Oracle Fusion Applications products, or other types of products or services that allow customers to subscribe to usage of those products or services.

FIG. 8 further illustrates the use of private label cloud realms for use by tenants or customers of a cloud infrastructure environment in accordance with an embodiment.

As illustrated in FIG. 8, in accordance with an embodiment, the system can include a cloud subscription service or component, such as an Oracle Cloud Subscriptions (OCS) service or component, that exposes one or more subscription management APIs for creating orders used to onboard new customers or to launch a workflow that creates a subscription and orchestrates billing and pricing service or other components for use with a PLC realm 400.

In accordance with an embodiment, when a PLC operator or their customer requests a PLC environment, the system creates a PLC realm for use with one or more provider-owned tenancies. A realm is a logical collection of one or more cloud regions that are isolated from each other and do not allow customer content to traverse realm boundaries to a region outside that realm. Each realm is accessed separately. PLC operators access cloud resources and services through a cloud tenancy. A cloud tenancy is a secure and isolated partition of a cloud infrastructure environment, and it only exists in a single realm. Within this tenancy, operators can access services and deploy workloads across all regions within that realm if policies allow.

In accordance with an embodiment, a first step in the process is to create an operator tenancy for the PLC operator before the realm and associated regions are turned over to them for subsequent management. The PLC operator then becomes the administrator of this tenancy with the ability to view and manage everything that happens within that realm, including their customer accounts and usage by those customers of cloud resources.

Generally, once the realm has been turned over or provided to the PLC operator, the cloud infrastructure provider cannot subsequently access the data within the operator tenancy unless the operator authorizes the cloud infrastructure provider to do so, for example, to provide troubleshooting for issues that may arise.

In accordance with an embodiment, the PLC operator can then create additional internal tenancies, intended for their own use internally, for example, to assess what the end customer experience will be, to provide a sales demo tenancy, or to operate a database for their own internal use. The operator can also create one or more customer tenancies that the end customer will be the administrator for. Cloud infrastructure usage metrics, for example, compute usage, storage usage, and usage of other infrastructure resources, may be consolidated by the operator, reflecting both operator usage and customer usage. Cloud infrastructure usage may be reported to the cloud infrastructure provider.

In accordance with an embodiment, a user interface or console can be provided that allows the PLC operator to manage its customer accounts and customer-offered services. A cloud infrastructure provider can also use a cloud infrastructure tenancy, for example, a Fusion Applications tenancy, to install any needed infrastructure services for use by the operator and their customers.

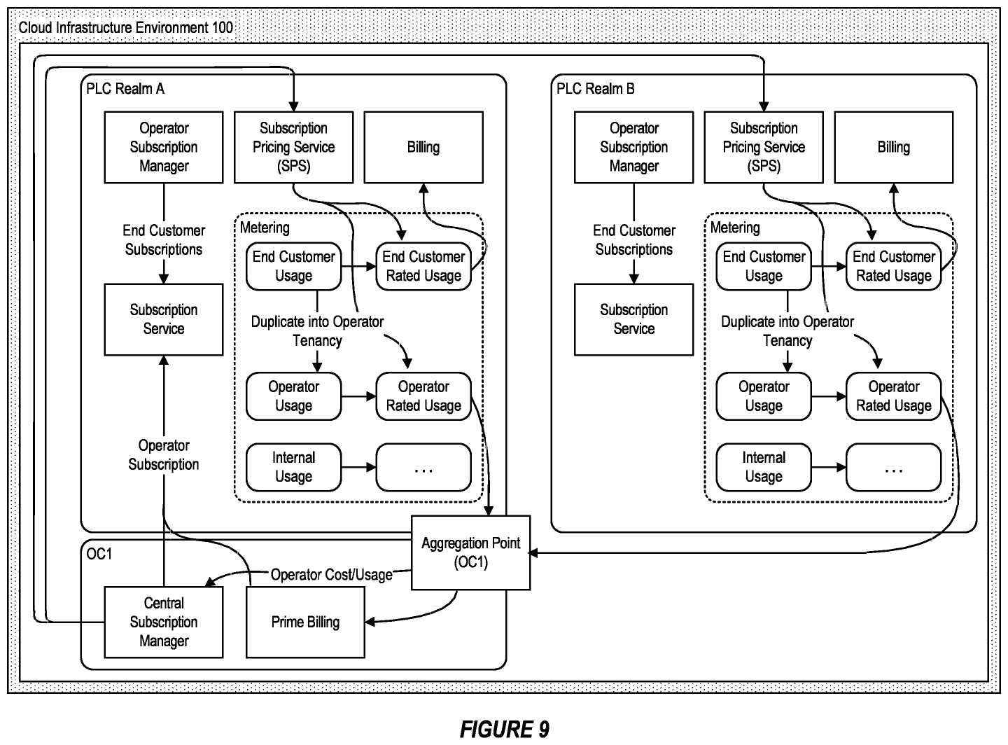

FIG. 9 further illustrates the use of private label cloud realms for use by tenants or customers of a cloud infrastructure environment in accordance with an embodiment.

As illustrated in FIG. 9, in accordance with an embodiment, a cloud subscription service or component exposes one or more subscription management APIs for creating orders used to onboard new customers or to launch a workflow that creates a subscription and orchestrates billing and pricing services or other components.

In accordance with an embodiment, the system can also include a billing service or component that operates upon a billing account or logical container of subscriptions and preferences used to produce an invoice for a customer.

In accordance with an embodiment, the system can also include a subscription pricing service (SPS) or component that operates upon a product catalog that defines the products that can be purchased by a customer. The subscription pricing service can also be used to provide a price list (e.g., a rate card) that the pricing service also owns.

In accordance with an embodiment, to support the sales process used to create a subscription in a PLC realm, products can be selected from a product hub. Once an order is created, a subscription is created in cloud subscription service that thereafter manages the life cycle of that subscription and provisions what needs to be provisioned in downstream services. The SPS component then manages the aspects of pricing and usage for use in charging the end cost to the PLC operator or their ability to charge their customers. Usage events are forwarded to the billing service or component, where, depending on the billing preferences of the subscription, invoices are created and pushed to an accounts receivables component.

In accordance with an embodiment, although the services that are offered in a realm report their usage to a metering service or component, such usage does not have any price associated with it. A rating process determines how much each specific event costs, for example, by applying rate cards, determines a unit and cost for that subscription, associates the cost to that record, and then forwards that to the billing service or component.

As further illustrated in FIG. 9, in accordance with an embodiment, a PLC operator may control multiple realms A, B. For, example an operator that operates in multiple countries may wish to operate a data center that is completely isolated for the United States of America and a separate data center that is completely isolated for Europe, for example, to address governance or regulatory requirements. In accordance with an embodiment, the usage associated with these multiple realms can be aggregated for use in billing the operator.

The examples of various systems illustrated above are provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Private Label Cloud Subscriptions

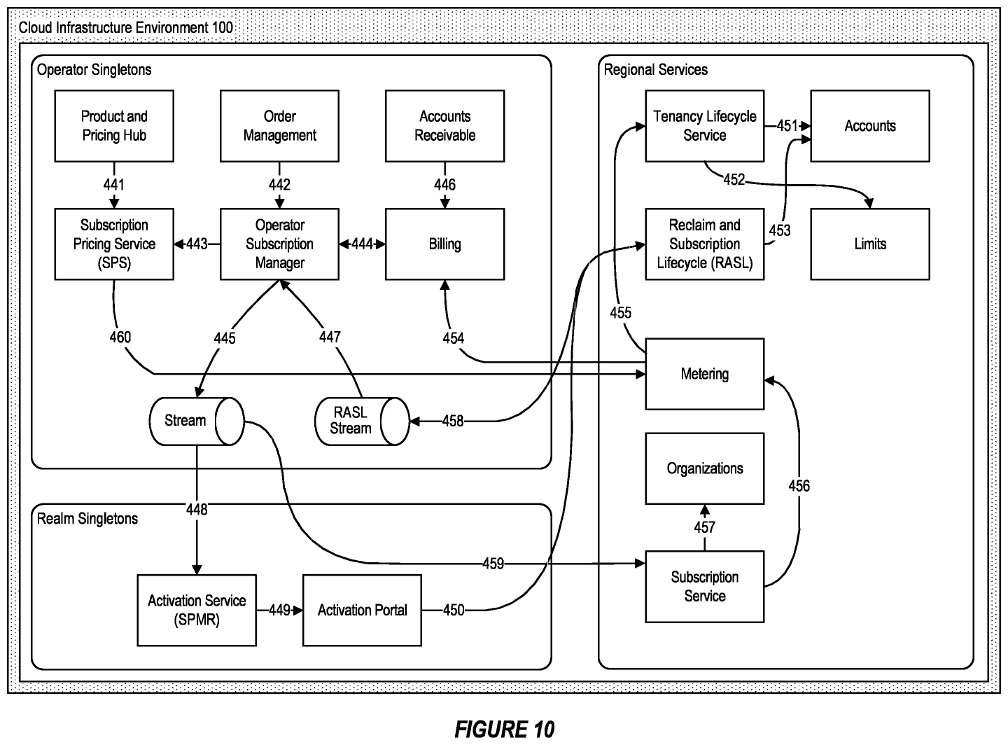

FIG. 10 illustrates a system for providing access to software products or services in a cloud computing or other computing environment in accordance with an embodiment.

As illustrated in FIG. 10, in accordance with an embodiment, the system can be provided as a cloud computing or other computing environment, referred to herein in some embodiments as a platform, that supports the use of subscription-based products, services, or other offerings.

Examples of such subscription-based products, services, or other offerings may include various Oracle Cloud Infrastructure (OCI) software products, Oracle Fusion Applications products, or other types of products or services that allow customers to subscribe to usage of those products or services.

In accordance with an embodiment, a subscription can include artifacts, such as products, commits, billing model, and state. The cloud subscription service can expose one or more subscription management APIs for creating orders used to onboard new customers or to launch a workflow that creates a subscription and orchestrates creating the proper footprints in billing and pricing service or components as further described below.

In accordance with an embodiment, the billing service or component operates upon a billing account or logical container of subscriptions and preferences used to produce an invoice. Each billing account generates one or more invoices per billing cycle. The billing service includes a first pipeline that accepts usage and cost from a metering service or component. Usage may be accepted through a REST API or another interface. The billing service writes the usage to a database from which balances may be calculated and aggregated by the billing service or other services. The billing service may include a second pipeline responsible for taking the aggregated usage and commitments and calculating charges over one or more billing intervals.

In accordance with an embodiment, the subscription pricing service (SPS) or component operates upon a product catalog that defines the products that can be purchased by a customer. The product catalog forms the backbone of a price list (i.e., rate card) that the pricing service also owns. Rate cards are modeled as pricing rules on top of public list prices. The pricing service maintains a single price list for each product; new product prices can be added and existing prices changed. The price list has a full history, the latest version being the current rate card. Since some contracts may require a snapshot of the rate card be taken, the pricing service handles this by recording the time a customer's rate card is created and then querying the price list at that time.

In accordance with an embodiment, the SPS or pricing service is responsible for providing information about products, global price lists, and end customer subscription specific price lists and discounts. For example, in accordance with an embodiment, the SPS can sync product information from a product hub (e.g., an Oracle Fusion Product Hub) and a global price list from a pricing hub (e.g., an Oracle Fusion Pricing Hub).

In accordance with an embodiment, the cloud subscription service operates as an upstream service to receive new order requests, for example, from an Oracle Fusion Order Management environment. The cloud subscription service can provide subscription information to the SPS service. Subscription details like time of quote, configuration, and subscription type (Commitment, PayG) help SPS to determine an effective base price (Rate Card) for the subscription. The cloud subscription service can also send discounts for subscriptions received, for example, from Oracle Fusion Order Management, that SPS stores as a pricing rule entity.

In accordance with an embodiment, the SPS service runs as a background process to manage a rate cards service or component responsible for generating rate cards for new subscriptions and updating when new price changes occur. The SPS service can expose APIs to access rate cards and pricing rules. A metering in-line rating engine can utilize these APIs to get subscription-specific rate cards and pricing rules using this data for cost calculations.

In accordance with an embodiment, additional SPS components can include, for example, a Pricing/Product Hub Oracle Integration Cloud (OIC) integration component, that allows a PLC operator entity providing subscription-based products, services, or other offerings within the environment to manage their product and price list, for example, as provided by an Oracle Fusion Product Hub and Oracle Fusion Pricing Hub, respectively.

For example, in accordance with such an embodiment, an SPS OIC product integration flow can listen to create/update events in the Product Hub and make calls to an SPS product API. Similarly, an SPS OIC pricing integration flow can pull new price list creations from the Pricing Hub and call respective SPS pricing APIs.

In accordance with an embodiment, the system can also include an SPS core module that provides APIs to manage and access pricing entities. Pricing can be accessed by internal services, such as an inline rating engine.

In accordance with an embodiment, the system can also include a rate card manager component. The SPS service maintains the single base price for a product at a given time. However, product prices for subscriptions are dependent on a base price at quote configuration time and price list change policy attributes of subscriptions. The SPS service internally maintains the price to be used for subscriptions using these properties. Such price lists are grouped in a rate card. The rate card manager can create and maintain the rate card as well as listen to price list changes and update existing rate cards with the new price. It also listens to new subscriptions and assigns the rate card based on subscription properties.

In accordance with an embodiment, the system can also include a rule decoder engine. The SPS service is responsible for managing pricing rules for a subscription, including discounts offered to an end customer. Pricing rules eligibility can be based on attributes of Products, like Discount group, Product Category, or specific SKUs. Internally, SPS needs to identify the list of products these rules will be applicable. To accomplish this, the rule decoder engine can compile the pricing rules in a format such that an in-line rating engine can consume for cost calculation. This compilation process can be triggered when products or pricing rules get created/updated.

As illustrated by way of example in FIG. 10, in accordance with an embodiment: at 441, a product and price information managed in, e.g., Fusion Applications, is sent to the SPS component. At 442, orders are sent to the cloud subscription service component to create subscriptions, rate cards, and billing accounts. At 443, pricing configuration and pricing rules are sent to SPS for new orders. At 444, the cloud subscription service is used to set up a billing account in the billing service or component. At 445, the cloud subscription service publishes events to an cloud infrastructure streaming component. At 446, charge data is sent to an accounts receivable component to generate invoices. At 447, cloud subscription service consumes reclaim and subscription lifecycle (RASL) events from cloud infrastructure streaming. At 448, an activation service reads the cloud subscription service event stream. At 449, a customer gets activation data from a portal. At 450, a tenancy lifecycle service provisions a tenancy as part of the subscription activation. At 451, the tenancy lifecycle service creates an accounts footprint during account provisioning. At 452, the tenancy lifecycle service sets a limits template during account provisioning. At 453, the accounts component acts as a downstream RASL client to handle legacy reclamation. At 454, aggregated cost and usage is sent to the billing service or component. At 455, an organization can create child tenancies using the tenancy lifecycle service. At 456, a metering service or component gets subscription mapping data. At 457, the subscription service gets organization data for subscription mappings. At 458, RASL reads cloud subscription service event stream. At 459, the subscription service reads cloud subscription service event stream; and at 460, the metering service or component gets a rate card data for each subscription that can then be used in charging the end cost to the PLC operator or their ability to charge their customers.

The above example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### 2. CROSS-DOMAIN APPROVAL

In accordance with an embodiment, enabling a cross-domain approval process may result in benefits in cloud environments generally, or in a variety of different cloud environment products such as in PLC products. For example, to deliver PLC product requirements, an identity service and/or an identity provider (e.g., IdP) can provide features to allow PLC operators to control resources in the cloud environment within their tenancies, such as the PLC Operator Tenancy, the PLC Internal Tenancies, and the PLC Customer Tenancies. Such resources may include host classes (service enclave and overlay) to control SSH access to compute instances, domain groups to control access to overlay resources, LDAP groups to control access to networking devices, integrated lights-out managers (ILOMs) and service enclave bastions, SmartNIC resources to control access to SmartNIC devices, Exadata resources to control access to Exadata servers, and other resources. To manage the resources, approval workflows can be provided to grant access and access reviews for reviewing access on periodic bases. For PLC operators to be able to fully control their assigned resources, they may use an identity service with approval workflow and access review capabilities.

In accordance with an embodiment, when complex troubleshooting is required, the realm operators (PLC operators) may not have the know-how to perform such troubleshooting or repairs. In such situations, it is desired that provider operators (e.g., cloud infrastructure provider operators, also referred to herein as “cloud infrastructure operators”) be able to perform such troubleshooting or repairs with the consent and approval of the PLC operators. A PLC operator may also enlist help from a cloud infrastructure operator for a variety of other reasons, including expertise related to complex issues, setup and configuration of new features, performance and optimization, security and compliance support, training and knowledge transfer, major upgrades and migration, and disaster recovery or backup assistance. For example, cloud infrastructure operators can be responsible for providing patches that impact the realm and for deploying service fixes and new features with PLC operators' explicit consent.Realm operators need a way to evaluate and approve requests by cloud infrastructure operators to access cloud resources for troubleshooting, repairing, or otherwise providing support. Additionally or alternatively, cloud infrastructure operators need to be able to request such access without unnecessarily exposing sensitive information, such as personally identifiable information (PII), to realm operators. Provided herein are systems and methods that manage security for a PLC realm based on multiple operator types and cross-domain approvals.

In accordance with an embodiment, provider operator access to realm operator resources can be controlled using an approval workflow. An operator access tenancy (OAT) can be bootstrapped into the realm and will be federated with an identity provider (e.g., Oracle IdP). Operator user accounts and tenancy groups memberships can be synchronized from an approval workflow using a synchronization process.

In accordance with an embodiment, SSH access to PLC regions can be gated by Zero-Trust Bastions (ZTB) that can record the contents of every SSH session. To facilitate PLC operators, access to necessary customization tools and read access for troubleshooting and monitoring a full Identity and Access Management (IAM) domain within the tenancy can be added and configured to federate with that IAM domain to the PLC partner's identity provider. This tenancy IAM domain can also be bootstrapped with a collection of groups that PLC operators can request. The PLC partner can also have the option of configuring group mappings from their IdP to one or more operator groups. The operator groups can be associated with access policies added by each service team that needs to expose access to PLC operators.

In accordance with an embodiment, a lightweight domain can contain every provider operator. This domain can be used during the bootstrap by provider operators to perform region build activities as well as post-delivery of the region to support the region. In accordance with an embodiment, this domain may be used for fail-safe access by only a limited number of operators post-delivery of the region in scenarios where more favored access mechanisms are unavailable. There can also be a second domain (operator access tenancy) that PLC operators can be federated to from an identify provider. PLC operators can see the operator access tenancy domain user groups segregated by function type, for example log_viewer, deployment_ viewer, service_configurator, etc. The groups will give access to one or multiple functions for every service.

In accordance with an embodiment, an access review service can allow creation of certification campaigns and configure, for example, a frequency of the certifications, a default action in case review is not completed, notification template, and so on. PLC operators can create certification campaigns for operator access tenancy domain groups. This will allow PLC administrators to perform periodic reviews to ensure the right operators have access to the desired groups. Access review for domain groups can be done via an approval workflow by provider operators. Operators can browse historical information from previous reviews for given groups to determine who remains, has been revoked, and/or completed certification.

In accordance with an embodiment, as an alternative to access policies, a combination of service roles may be defined for each service. This allows the identity management system to give permissions to subjects and business roles defined by each of the service teams. By combining those service roles to grant sufficient access to manage the service managing these roles becomes more efficient. Use of approval workflows and periodic access review can support the use of role-based access control (RBAC) for managing internal services. This, in turn, allows a transition of requests for operator access from a platform provider approval workflow directly into an identity service.

In accordance with an embodiment, when a PLC region is provisioned, the operator access tenancy can be provisioned and federated with the provider identity provider (e.g., IdP). Some or all of the provider operators can be bootstrapped in the lightweight domain sufficient to bring the region up to an operating state where a full identity domain can be provisioned. Then, the provider identity provider and the operator identity provider are federated with the IAM domain.

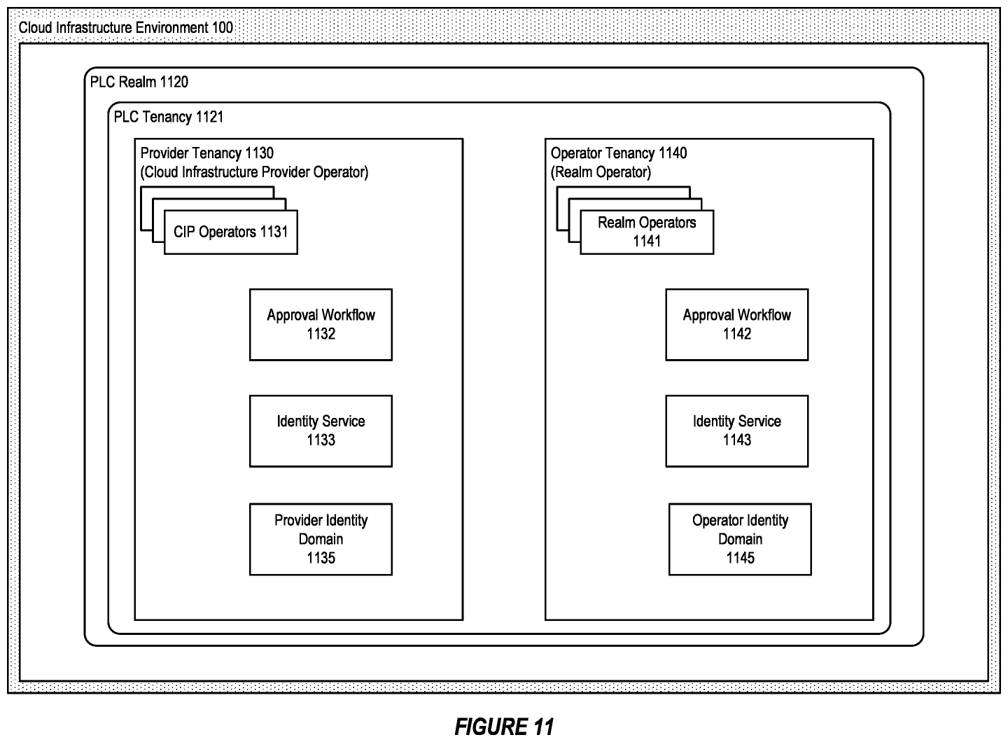

FIGS. 11-17 illustrate a system for managing security for a PLC realm based on multiple operator types and cross-domain approvals, in accordance with an embodiment.

In one or more embodiments, cloud infrastructure environment 100 may include more or fewer components than the components illustrated in FIGS. 11-17. The components illustrated may be local to or remote from each other. The components illustrated may be implemented in software and/or hardware. Each component may be distributed over multiple applications and/or machines. Multiple components may be combined into one application and/or machine. Operations described with respect to one component may instead be performed by another component.

In one or more embodiments, a data repository is any type of storage unit and/or device (e.g., a file system, database, collection of tables, or any other storage mechanism) for storing data. Further, a data repository may include multiple different storage units and/or devices. The multiple different storage units and/or devices may or may not be of the same type or located at the same physical site. Further, a data repository may be implemented or executed on the same computing system or systems as cloud infrastructure environment. Additionally, or alternatively, a data repository may be implemented or executed on a computing system separate from cloud infrastructure environment. The data repository may be communicatively coupled to cloud infrastructure environment via a direct connection or via a network.

In an embodiment, cloud infrastructure environment 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, an IAM interface refers to hardware and/or software configured to facilitate communications between an operator and an identity access management system. An IAM interface renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of an IAM interface are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, an IAM interface is specified in one or more other languages, such as Java, C, or C++.

As illustrated in FIGS. 11-17, in accordance with an embodiment, the system can be provided as a cloud computing or other computing environment, referred to herein in some embodiments as a platform, that supports the use of subscription-based products, services, or other offerings. Examples of such subscription-based products, services, or other offerings may include various Oracle Cloud Infrastructure (OCI) software products, Oracle Fusion Applications products, or other types of products or services that allow customers to subscribe to usage of those products or services.

In accordance with embodiments represented by FIGS. 11-17, within a cloud infrastructure environment 100, such as an OCI environment, a PLC tenancy 1121 can be defined within a PLC Realm 1120 (e.g., Alloy Realm). Within the tenancy, a provider tenancy 1130 and an operator tenancy 1140 can be provisioned. The provider tenancy can comprise, e.g., an administrative domain and/or a tenancy configured for the cloud infrastructure provider, while the operator tenancy can comprise a realm operator tenancy (e.g., an OCI customer operating as a reseller). There can be several operators, such as cloud infrastructure provider (CIP) operators 1131 associated with provider tenancy 1130 and realm operators 1141 associated with the operator tenancy 1140.

In accordance with embodiments represented by FIGS. 11-17, within each tenancy, there can be provided an approval workflow 1132 and 1142 as well as an identity services 1133 and 1143. In an embodiment, identity service 1133 is associated with provider identity domain 1135, and identity service 1143 is associated with operator identity domain 1145.

In an embodiment, an identity domain is a technical construct within the Identity and Access Management (IAM) system that functions as a namespace for managing access and identities specific to a set of cloud resources. It orchestrates user/operator authentication, authorization, and security policy enforcement. Each identity domain isolates user management, role definitions, and access controls, enabling segregation of administrative domains for different organizational units or customer groups. It supports functionalities like user creation, role-based access control, access rights management, and identity federation integration. In a multi-tenant cloud environment, the identity domain ensures distinct access boundaries are maintained across various tenants, facilitating resource and service access management in line with predefined security protocols. This allows for granular control over user permissions and resource access within Oracle's cloud infrastructure.

In an embodiment, identity services 1133 and 1143 include services related to user authentication, authorization, user management, role and policy management, and security protocol enforcement. These identity services are responsible for ensuring that access to various resources and services is limited to authenticated and authorized users within their respective environments associated with their identity domains. In an embodiment, identity domains 1135 and 1145 provide the context or the environments where identity services 1133 and 1143 operate. Identity services 1133 and 1143 perform the actual tasks of authentication and authorization, and the identity domains 1135 and 1145 determine the scope (e.g., users, groups, and policies) of these tasks. For any given operation within the environment, the identity services 1133 and 1143 reference the configurations and rules defined within the relevant identity domains 1135 and 1145, respectively, to authenticate users and authorize access to resources. In an embodiment, there can be multiple identity domains within the same PLC environment, each managed by the same identity service, by a different identity service, or by a separate instance of the same identity service.

In an embodiment, when an operator initiates a request for access changes, new user additions, or role modifications, this request triggers the workflow within the identity management system. The system is configured to outline the necessary approval steps and determine the individuals or groups required to approve the request and under what conditions.

In an embodiment, the request is automatically routed based on predefined IAM policies, reaching the designated approvers who then review it against the organization's security policies and the specific needs for the access change. This workflow may incorporate conditional logic, requiring the request to meet certain criteria or obtain multiple approvals, especially for sensitive access levels or critical resources. Each action in this process is logged, creating an audit trail for accountability and traceability. Upon receiving the necessary approvals, the system implements the changes; if the request is denied or fails to meet the required conditions, it is either canceled or sent back for modification. In an embodiment, relevant parties are notified of the outcome, ensuring transparency and adherence to the established governance framework.

As configured, the respective approval workflows 1132 and 1142 can be configured the same or differently. That is, for example, while both approval workflows can be utilized within each respective tenancy to provide for or approve or allow access to resources associated with each respective tenancy, the rules set up within each respective approval workflow can be the same or can be different. This allows a realm operator to control and customize the rules by which their approval workflow 1142, runs, which can be the same or different from that of a default configuration or that may mirror that of approval workflow 1132.

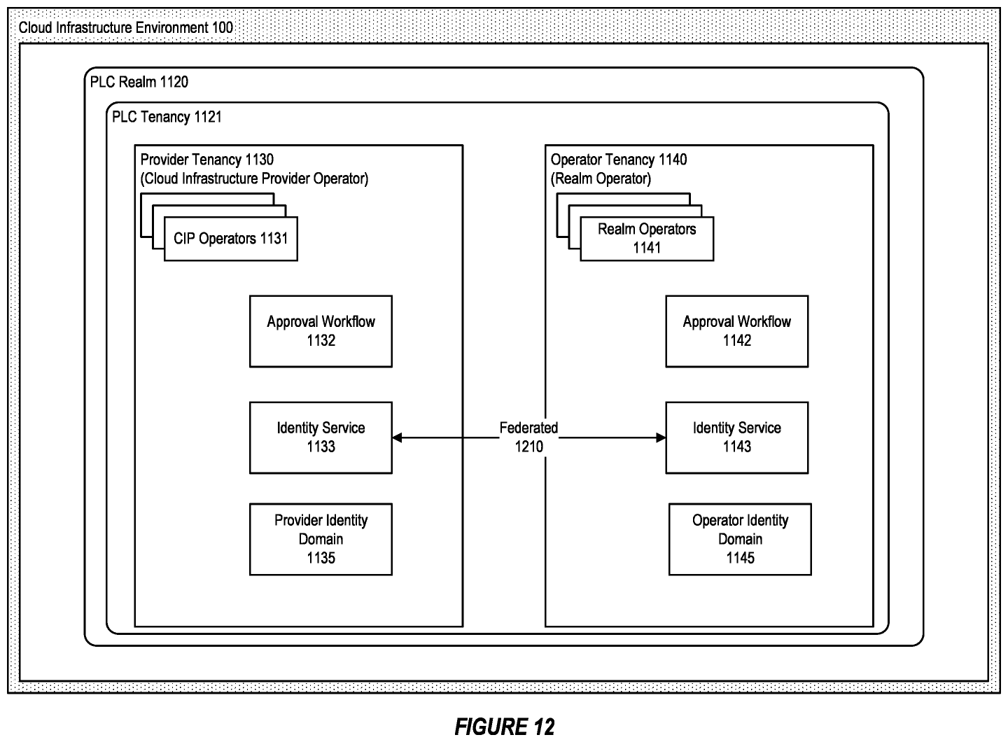

In accordance with an embodiment, as represented by FIG. 12, the identity service 1133 can be federated 1210 to identity service 1143 within the operator tenancy to facilitate cross-domain approvals. For example, while there can be two instances of the identity service 1133 and 1143, each identity service may work together as a single service for general or specific purposes, such as in the presently described embodiment, allowing operators within the cloud infrastructure provider tenancy access to resources associated with the realm operator's tenancy.

In an embodiment, each identity domain may also be federated with another system by linking to an external identity provider or another identity management system, enabling a shared approach to authentication and access management. This federation creates a trusted relationship between the identity domain and the external system that may use proprietary protocols or standard protocols like SAML (Security Assertion Markup Language) or OAuth. A feature enabled by this federation may include Single Sign-On (SSO) that allows users to log in once with their primary credentials (like corporate credentials) and gain access to multiple systems, including the federated identity domain, without the need for repeated authentication.

In an embodiment, operators using identity service 1133 and identity service 1143 are required to authenticate for their respective identity domains via different external identity providers. For example, identity service 1133 may be associated with an identity access provider chosen by administrators for a first company or entity, while identity service 1143 may be associated with a different identity access provider chosen by administrators for a second, different company or entity. In an embodiment, identity service 1133 and identity service 1143 are federated with one or more of the same external identity providers. In an embodiment, identity service 1133 and identity service 1143 are federated with multiple external identity providers. Identity service 1133 and identity service 1143 may use different authentication processes in an embodiment.

In an embodiment, during access attempts, the operator is authenticated by its home identity provider, and upon successful authentication, the provider issues a token (such as a SAML assertion) back to the identity domain. This token contains user information and permissions that enable the identity domain to grant appropriate access.

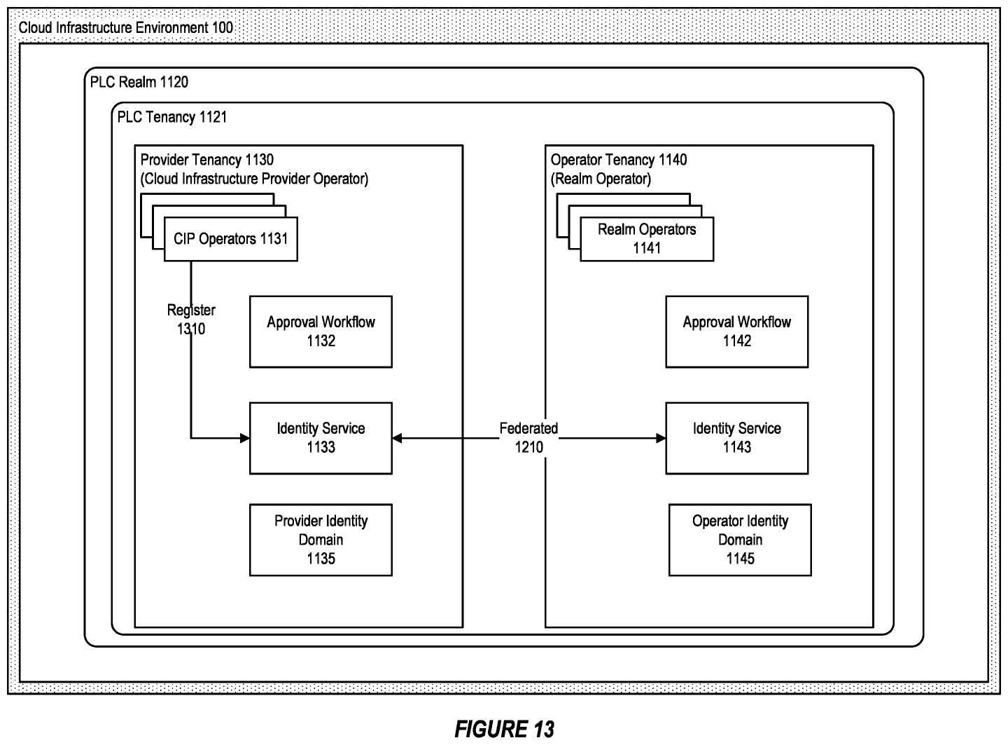

In accordance with an embodiment represented by FIG. 13, a CIP operator 1131 can register/provide necessary information 1310 to the identity service 1133 within the provider tenancy such that the CIP operator is a registered user. This information 1130 can include the identifying information of the CIP operator 1131, such as the CIP operator's uniquely identifying information as well as the CIP operator's personal identifying information (PII). In an embodiment, Identity service 1133 comprises an identity domain that is federated with an external identity management system. To authenticate with identity service 1133, the CIP operator must satisfy the requirements of the external identity management system if one exists.

In accordance with an embodiment, after an operator 1131 has registered/logged in 1310 with the identity service, the credentials and other information of the operator are not exchanged after an initial login, e.g., as long as the user's session is active. API calls made by the operator can, after registering/logging in, be authenticated with an operator private key or a session key that allows the service that is processing the request to authenticate the caller. Calls to approval workflow, such as to start a new workflow or execute an approval workflow, can follow the same procedure.

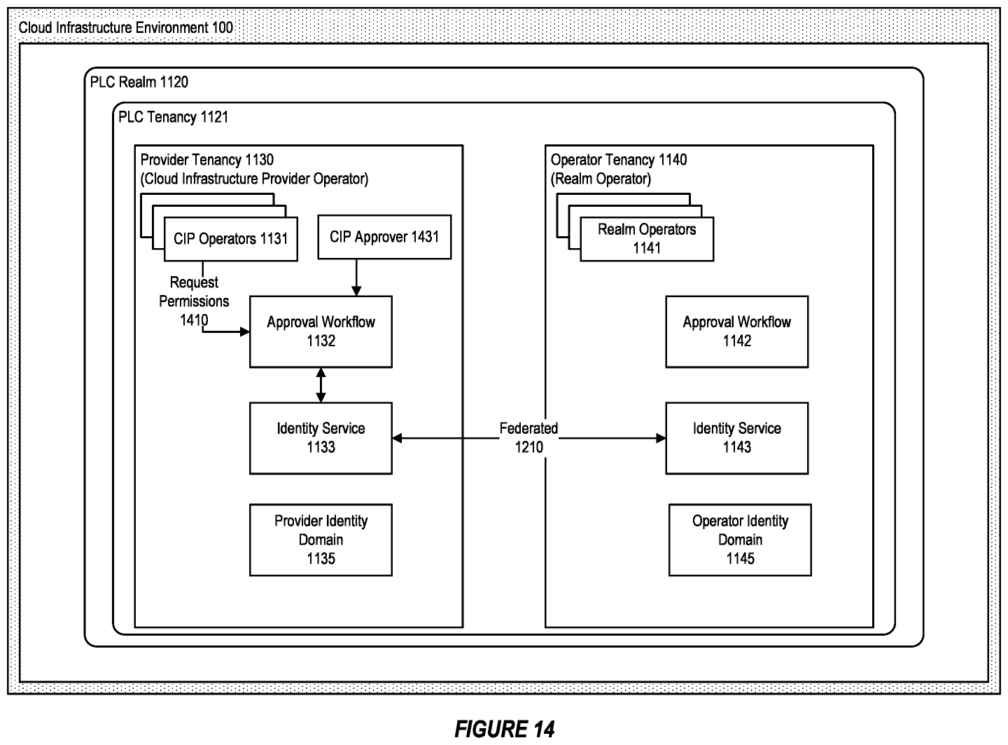

In accordance with an embodiment, as depicted in FIG. 14, after registering with the identity service, a CIP operator 1131 can request permissions 1410 via the approval workflow 1132 for access to a resource or to be assigned to a group with resource access within the operator tenancy 1140. For example, an operator seeking inclusion in a group with specific permissions may submit a role request through an IAM interface, specifying the desired group or role and its permissions. This request is recorded in the system's logs with details such as the requester's identity and metadata associated with the request. Identity service 1133 then triggers a workflow, such as approval workflow 1132, routing the request to designated decision-makers within the associated identity domain for approval. These decision-makers receive notifications and review the request against organizational policies and the specific needs of the role. In an embodiment, decisions are automated. Decision-makers may consult additional information, such as the operator's job responsibilities or previous access patterns, to inform their decision. If the request requires multi-level approval, it is forwarded to subsequent approvers upon initial approval. In conjunction with the identity service and based upon input received from an approver 1431 within the CIP tenancy, the request 1410 can be approved or denied. Once the final approval is granted, identity service 1133 system automatically updates the operator's access rights, adding them to the specified group or role with the corresponding permissions. The operator is then notified of the successful role assignment, completing the process.

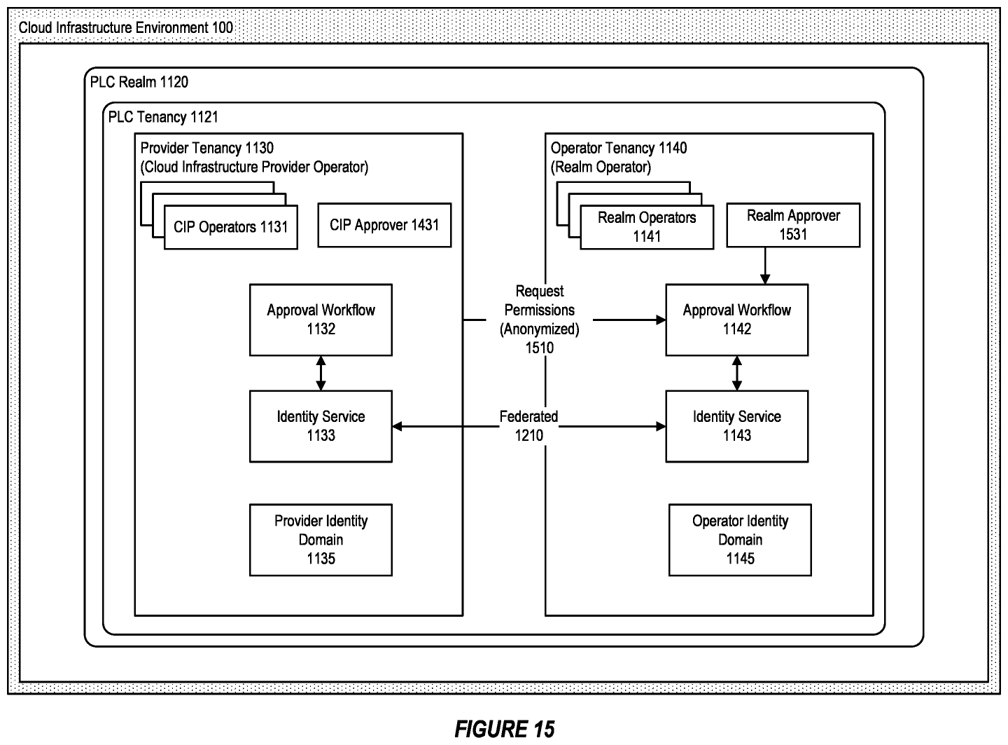

In accordance with an embodiment, as depicted in FIG. 15, a CIP operator 1131 can initiate a cross-domain approval to request permissions 1510, via the approval workflow 1142, for access to a resource or to be assigned to a group with resource access within the operator tenancy 1140. Although identity service 1143 is configured to use approval workflow 1142 to facilitate approvals for members of the operator identity domain, the workflow is configured to handle requests associated with the provider identity domain. The request 1510 may have already been approved by the CIP Approver 1431 in the previously described step. Request 1510 is received at the approval workflow 1142 at the operator tenancy with the personal identifying information of the requesting operator stripped from the request. The approval workflow 1142 can process the request for approval in conjunction with the identity service 1143 at the operator tenancy 1140, assuming the identity service at the operator tenancy is federated 1210 with the identity service 1133 at the provider tenancy. This is performed in conjunction with a realm approver 1531, where the realm approver 1531 is separate and different from the CIP approver 1431.

In accordance with an embodiment, identity service 1133 is associated with provider identity domain 1135, and identity service 1143 is associated with operator identity domain 1145. The CIP operator is associated with provider identity domain 1135 but not operator identity domain 1145. In an embodiment, provider identity domain 1135 and operator identity domain 1145 comprise different identities. In an embodiment, when the CIP operator requests approval to access a resource in PLC tenancy 1121, identity service 1143 reviews the information associated with the request. In response to determining that the CIP operator is associated with provider identity domain 1135, identity service 1143 grants the request. In an embodiment, this completes a successful cross-domain approval resulting from an operator associated with provider identity domain 1135 obtaining permission to request and obtain from an identity service managing operator identity domain 1145 to access a target resource associated with an operator tenancy. The result is an approval by an identity service associated with operator identity domain 1145 of access for an operator associated with provider identity domain 1135 that is different from operator identity domain 1145.

In accordance with an embodiment, the cross-domain approval process is performed in response to authorization by identity service 1133 (with respect to provider identity domain 1135) to make a request for approval associated with operator identity domain 1145 and identity service 1132. Once approved in connection with provider identity domain 1135, a cross-domain approval process may be initiated. The approval with respect to provider identity domain 1135 is an approval to make a cross-domain approval request for access to a target resource, access control that is reserved for operators associated with operator identity domain 1145 or for operators from another identity domain able to complete a cross-domain approval process.

In accordance with an embodiment, no end user credential is passed between the provider tenancy and the operator tenancy during such a request. The request, prior to being transferred to the operator tenancy, can comprise a payload that has information on what is being requested and who the requestor is. Prior to communication to the operator tenancy, the request can be anonymized such that the caller from the cloud infrastructure identity domain (e.g., OCI domain) referenced in the payload cannot be discerned by the operator tenancy.

In accordance with an embodiment, an end user credential is passed between the provider tenancy and the operator tenancy during such a request without providing personal information associated with the operator making the request.

In accordance with an embodiment, as the caller information is anonymized, the approval workflow 1142 can rely on the identity service 1143 that is federated to identity service 1133 to authenticate calls that are made to it by an end user. When an operator first authenticates/registers their public key with identity service 1133, the operator can then use their private key to sign requests. The approval workflow 1142 integrates with the identity service 1143 to authenticate signed requests.

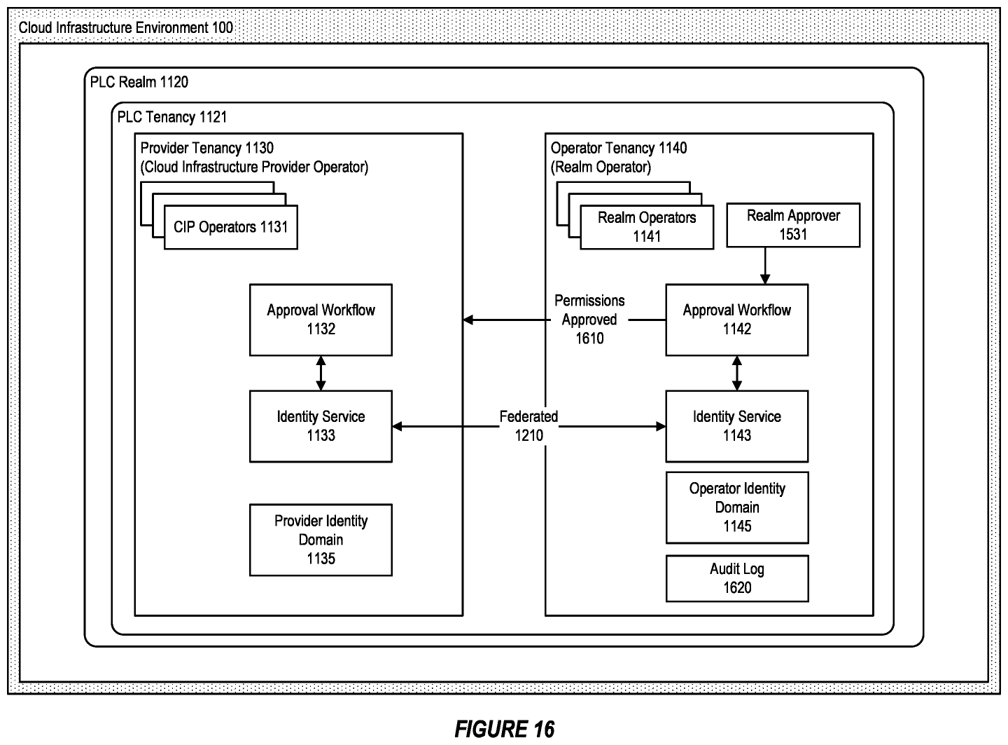

In accordance with an embodiment, as depicted in FIG. 16, a CIP operator 1131 has requested permissions for access to a resource within the operator tenancy or to be assigned to a group with resource access within the operator tenancy 1140. The request is then received at the approval workflow 1142 at the operator tenancy with the personal identifying information of the requesting operator stripped from the request. The approval workflow 1142 in conjunction with the identity service 1143 and realm approver 1531 can process the request for approval. The identity service at the operator tenancy 1140 is federated 1210 with the identity service 1133 at the provider tenancy. The realm approver 1531 is separate and different from the CIP approver. In addition, each workflow may have more than one approver in addition to other decision points that include automated approval or rejection of requests. If permission is granted/approved 1610, the operator within the provider tenancy 1130 may then access and modify, update, or otherwise act on the target resources within the operator tenancy. In an embodiment, approval results in adding the CIP operator 1131 to one or more roles or groups that have access to the target resources. The CIP operator 1131 may be referenced using a unique identifier without including personally identifiable information about the operator. In an embodiment, approval results in granting CIP operator 1131 the necessary credentials for accessing the target resource. For example, a username and password may be created within the second identity domain, and/or the operator may be granted a digital certificate or other authentication mechanisms that provide access to the target resource. In an embodiment, credentials used by CIP operator for the first identity domain may be logically associated with the second identity domain. Once CIP operator 1131 is assigned the appropriate role and/or credentials, CIP operator 1131 may request access to the target resource; after that, the request will be granted based on the assigned role and/or credentials. In an embodiment, the request is granted based on the approval of the request.

In accordance with an embodiment, as the personal identifying information of the CIP operator 1131 acting within the operator tenancy has been stripped, an audit log 1620 may reflect the actions taken by the CIP operator 1131 by utilizing information that does not personally identify the operator such as a uniquely assigned ID associated with the operator 1131.

### 4. EXAMPLE EMBODIMENTS

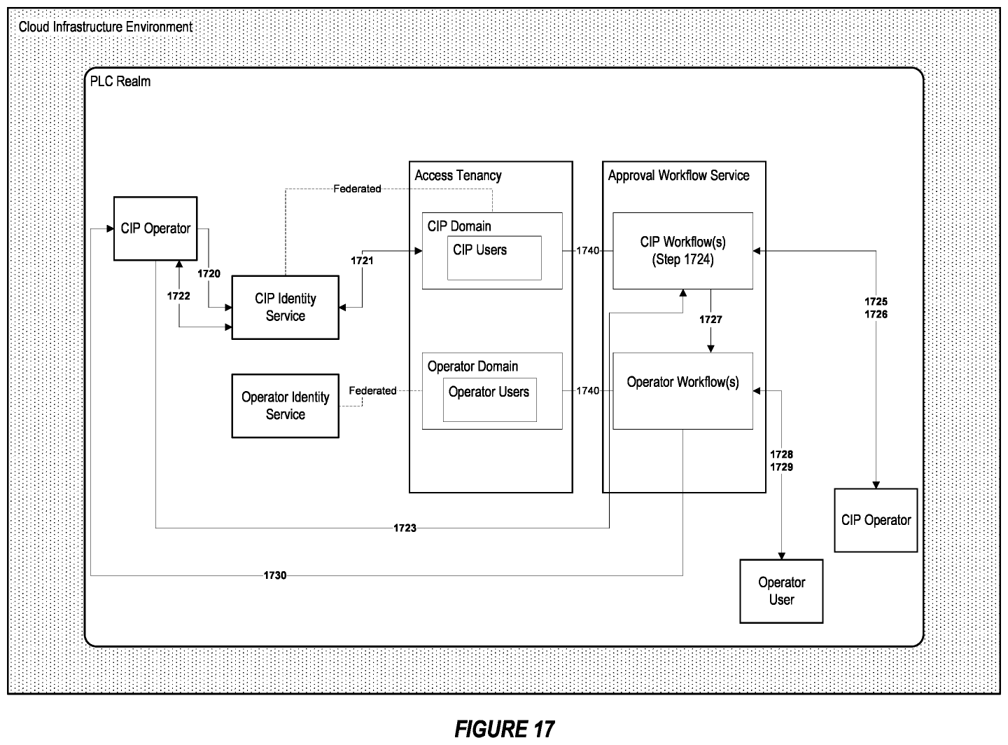

FIGS. 17-19 illustrate example sets of operations in accordance with one or more embodiments. One or more operations illustrated in FIGS. 17-19 may be modified, rearranged, or omitted. Accordingly, the sequence of operations illustrated in FIGS. 17-19 should not be construed as limiting the scope of one or more embodiments.

Initially, a CIP operator logs in via the CIP identity service that may be federated to a CIP identity domain (Operation 1720). To trust each other's identity assertions, they may establish this trust through the exchange of metadata, which may include information like public keys used for signing tokens or assertions. The CIP identity domain then trusts the CIP identity service to authenticate users. The exchange of authorization and authentication may take place through the use of SAML or other standards. The operator identity service may likewise be federated to an operator identity domain.

The CIP operator is authenticated by checking against provider identity domain that can have defined therein a number of CIP users (Operation 1721). This may start with an access request for a resource that requires authentication. If the CIP operator is not already authenticated, it is redirected to an identity service. Redirection may be done via a web browser or through another mechanism. The CIP operator may present credentials, which may require a username and password, two-factor authentication, biometrics, or other credentials. If the CIP operator has used a single sign on service, credentials may not need to be provided for a period of time.

On a valid authentication, a credential (e.g., valid user credential, session credential, SSO credential, etc.) is passed back to the CIP operator (Operation 1722). The identity provider may manage the session, which may include tracking the CIP operator's authentication state and, in some cases, providing a way to log out from all federated services at once.

Once authenticated, the CIP operator can submit a request comprising of a requested role and the credential to one or more CIP workflows at the approval workflow service (Operation 1723). This request may be for access to a resource not associated with the CIP identity domain. For example, the request may be for access to a resource associated with the operator identity domain.

The system triggers the initiation of one or more of the CIP workflows based on the received request comprising the requested role and the credential (Operation 1724). For example, the workflow(s) to be initiated may be based on the requesting CIP operator, permissions already associated with the CIP operator, the requested resource, or other factors such as whether the CIP operator has recently been granted the requested permissions. Workflows may be selected by a strict mapping of conditions to workflows or may be selected dynamically by determining which acceptable workflows are more likely to result in efficient resolution. For example, of two acceptable workflows are available, but an operator associated with one of the workflows is known to be unavailable or less likely to respond, the alternate workflow may be selected for initiation.

The one or more workflows submit an approval request to a CIP operator (Operation 1725). The CIP operator can, for example, comprise an operator having approval authority for the one or more workflows running. The approval request to the CIP operator can comprise information that identifies the requesting CIP operator. More than one approver or approval operation may be required by the workflow. For example, the workflow may include rules that determine whether an approver will even be tasked with reviewing the request. Also, two or more approvers may be required to approve some requests.

Upon the CIP operator approving the request, such approval can be sent to the CIP workflow (Operation 1726). For example, the workflow may trigger a service that results in a request sent to an approver by the service. Once the service receives a satisfactory response from the approver, it may communicate with the workflow service to confirm the approval.

Upon the approval being received at the one or more CIP workflows, one or more Operator workflows are initiated (Operation 1727). Alternatively, the operator workflow may be initiated separately, in response to a request to activate permissions. One or more requests for approval are received, with at least one of the requests comprising an indicator indicating that approval has been received from one or more CIP workflows (Operation 1728). The approval request to the operator does not comprise information identifying the CIP operator. The request may include an identifier such as an OID but does not include the name or username of the CIP operator.

Confirmation of the approval is transmitted to operator workflow 1708 (Operation 1729), and CIP operator is added to the requested role (Operation 1730).

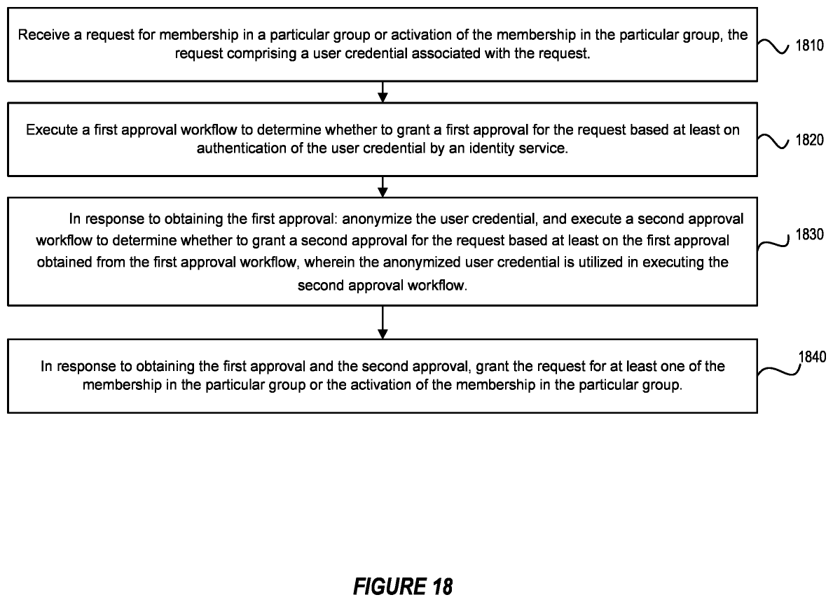

FIG. 18 illustrates an example set of operations for performing a cross-domain approval in accordance with an embodiment.

In accordance with an embodiment, a request for membership in a particular group or activation of the membership in the particular group is received. The request comprises a user credential associated with the request (Operation 1810).

In accordance with an embodiment, a first approval workflow is executed to determine whether or not to grant a first approval for the request based at least on authentication of the user credential by an identity service (Operation 1820).

In accordance with an embodiment, responsive to obtaining the first approval, the user credential is anonymized, and a second approval workflow is executed to determine whether or not to grant a second approval for the request based at least on the first approval obtained from the first approval workflow, wherein the anonymized user credential is utilized in executing the second approval workflow (Operation 1830).

In accordance with an embodiment, responsive to obtaining the first approval and the second approval, the request is granted for either the membership in the particular group or the activation of the membership in the particular group (Operation 1840).

In accordance with an embodiment, the method can be performed on a computer comprising one or more microprocessors.

In accordance with an embodiment, the first approval workflow can be associated with a first tenancy that is federated to the identity service, and the second approval workflow can be associated with a second tenancy that is federated to a second identity service. Additionally, the first tenancy may not have access to the second identity service, and the second tenancy does not have access to the identity service.

In accordance with an embodiment, the method can receive a second request for access to a resource, the second request comprising the credential. The method can determine that access to the resource is permitted to users who have membership in the group. The method can determine that the user credential is associated with the membership in the group. The second request for access to the resource can be granted.

In accordance with an embodiment, the resource can reside in a cloud environment.

In accordance with an embodiment, an audit log entry associated with the granting of access to the resource can be logged without indicating the user credential.

In accordance with an embodiment, the method can receive a second request for access to a resource, the second request comprising the user credential. The method can determine that access to the resource is permitted to users who have the activation of the membership in the group. The method can determine that the user credential is associated with the activation of the membership in the group. The method can grant the second request to access the resource.

In accordance with an embodiment, the first approval workflow and the second approval workflow can each be defined by different entities.

In accordance with an embodiment, the first approval workflow can be associated with a first tenancy associated with the identity service, and the second approval workflow can be associated with a second tenancy associated with a second identity service.

### 5. VARIATIONS

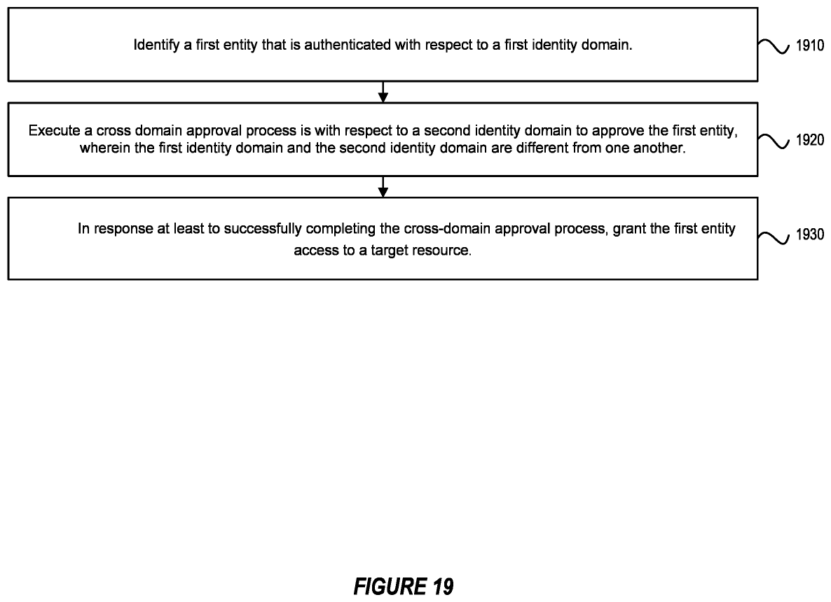

FIG. 19 illustrates an example set of operations for performing a cross-domain approval in accordance with an embodiment.

In accordance with an embodiment, first entity that is authenticated with respect to a first identity domain is identified (Operation 1910).

In accordance with an embodiment, a cross-domain approval process is executed with respect to a second identity domain to approve the first entity. In an embodiment, the first identity domain and the second identity domain are different from one another (Operation 1920).

In accordance with an embodiment, in response to successfully completing the cross-domain approval process, the first entity is granted access to a target resource (Operation 1930).

In accordance with an embodiment, the first identity domain and the second identity domain comprise different identities.

In accordance with an embodiment, the first identity domain and the second identity domain are federated with different identity providers.

In accordance with an embodiment, the first identity domain and the second identity domain are associated with different authentication processes.

In accordance with an embodiment, the first approval process with respect to the second identity domain comprises obtaining one or more approvals from one or more users authenticated with respect to the second identity domain.

In accordance with an embodiment, successfully completing the first approval process indicates that the first operator who is authenticated with respect to the first identity domain is also approved with respect to the second identity domain.

In accordance with an embodiment, granting the approval to access the target resource comprises adding the first operator to a role associated with having access to the target resource.

In accordance with an embodiment, granting the approval to access the target resource comprises granting the first operator the necessary credentials for accessing the target resource.

In accordance with an embodiment, granting the approval to access the target resource comprises establishing the necessary access policies for the first operator to access the target resource.

In accordance with an embodiment, a request is received from the first operator to access the target resource based on the granted approval, and access to the target resource is granted.

In accordance with an embodiment, access to the target resource by the first operator is granted based on the approval.

In accordance with an embodiment, executing the cross-domain approval process is further responsive to authorizing, with respect to the first identity domain, the first operator to make the request for approval.

In accordance with an embodiment, executing the cross-domain approval process includes executing the first approval process based at least in part on an identity access management credential corresponding to the first operator that is not accompanied by personal information corresponding to the first operator.

In accordance with an embodiment, executing the cross-domain approval process includes executing a second approval process based at least in part on an identity access management credential corresponding to the first operator that is accompanied by personal information corresponding to the first operator.

In accordance with an embodiment, executing the cross-domain approval process comprises successfully completing the first approval process, wherein completing the first approval process is responsive in part to completing the second approval process with respect to the first identity domain.

In accordance with an embodiment, executing the first approval process comprises logging an identifier without logging a username associated with the first operator. Furthermore, executing the second approval process comprises logging an identifier and a username associated with the first operator.

In accordance with an embodiment, the second approval process is processed in reliance on (a) the approval from the second approval process with respect to the first identity domain, and (b) the authorization within the first identity domain that the first operator is authorized to make the request for approval.

In accordance with an embodiment, a second operator associated with the second identity domain is identified, wherein the second operator has been authenticated by executing a second authentication process corresponding to the second identity domain. The second operator is authorized by executing a second authorization process corresponding to the second identity domain. The second operator is permitted to perform a second operation that accesses a second resource in the first tenancy based at least in part on the second authorization process.

In accordance with an embodiment, the first approval process with respect to the first identity domain and the second approval process with respect to the second domain are executed by a same service.

In accordance with an embodiment, the first identity domain is associated with a cloud provider and the second identity domain is associated with a cloud reseller.

### 6. MISCELLANEOUS; EXTENSIONS

Unless otherwise defined, each term (including technical and scientific terms) is to be given its ordinary and customary meaning to a person of ordinary skill in the art and is not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in that such claims issue, including any subsequent correction.

What is claimed is:

1. One or more non-transitory computer readable media comprising instructions that, when executed by one or more hardware processors, cause performance of operations comprising:
identifying a first entity that is authenticated with respect to a first identity domain;
based at least in part on the first entity being authenticated with respect to the first identity domain, executing a cross-domain approval process comprising a first approval process with respect to a second identity domain to approve access for the first entity authenticated with respect to the first identity domain, wherein the first identity domain and the second identity domain are different; and
responsive at least to successfully completing the cross-domain approval process, granting to the first entity, access to a target resource.

2. The non-transitory media of claim 1, wherein the first identity domain and the second identity domain comprise different identities, and wherein the first identity domain and the second identity domain are federated with different identity providers.

3. The non-transitory media of claim 1, wherein the operations further comprise: selecting the cross-domain approval process, comprising the first approval process with respect to the second identity domain, based on a relationship between the target resource and the second identity domain.

4. The non-transitory media of claim 1, wherein the first entity is associated with both a first identity principal related to the first identity domain and a second identity principal related to the second identity domain, wherein the first entity is authenticated with respect to the first identity domain based on the first identity principal associated with the first entity, and wherein the cross-domain approval process with respect to the second identity domain is based on the second identity principal associated with the first entity.

5. The non-transitory media of claim 1, wherein the first identity domain and the second identity domain are associated with different authentication processes, and wherein the operations further comprise:
identifying a second entity that is authenticated with respect to the second identity domain;
executing the first approval process with respect to the second identity domain to approve access for the second entity authenticated with respect to the second identity domain; and
responsive at least to successfully completing the first approval process with respect to the second identity domain to approve access for the second entity, granting, to the first entity, access to a target resource.

6. The non-transitory media of claim 1, wherein the first approval process with respect to the second identity domain comprises obtaining one or more approvals from one or more users authenticated with respect to the second identity domain.

7. The non-transitory media of claim 1, wherein successfully completing the first approval process indicates that the first entity who is authenticated with respect to the first identity domain is also approved for access with respect to the second identity domain.

8. The non-transitory media of claim 1, wherein granting access the target resource comprises one or more of:
adding the first entity to a role associated with having access to the target resource;
granting, to the first entity, credentials for accessing the target resource;
establishing access policies for the first entity to access the target resource.

9. The non-transitory media of claim 1, wherein executing the cross-domain approval process is further responsive to authorizing, with respect to the first identity domain, the first entity to make a request for approval.

10. The non-transitory media of claim 1, wherein executing the cross-domain approval process includes executing the first approval process based at least in part on an identity access management credential corresponding to the first entity that is not accompanied by personal information corresponding to the first entity.

11. The non-transitory media of claim 10, wherein executing the cross-domain approval process includes executing a second approval process based at least in part on an identity access management credential corresponding to the first entity that is accompanied by personal information corresponding to the first entity.

12. The non-transitory media of claim 11, wherein executing the cross-domain approval process comprises successfully completing the first approval process, wherein completing the first approval process is responsive in part to completing the second approval process with respect to the first identity domain.

13. The non-transitory media of claim 11, wherein executing the first approval process comprises logging an identifier without logging a username associated with the first entity, and executing the second approval process comprises logging an identifier and a username associated with the first entity.

14. The non-transitory media of claim 13, wherein the second approval process is processed in reliance on (a) the approval from the second approval process with respect to the first identity domain, and (b) authorization within the first identity domain that the first entity is authorized to make a request for approval.

15. The non-transitory media of claim 1, wherein the operations further comprise:
identifying a second entity associated with the second identity domain, wherein the second entity has been authenticated by execution of a second authentication process corresponding to the second identity domain;
authorizing the second entity, associated with the second identity domain, by executing a second authorization process corresponding to the second identity domain; and
wherein the second entity is permitted to perform a second operation that accesses a second resource based at least in part on the second authorization process.

16. The non-transitory media of claim 11, wherein the first approval process with respect to the first identity domain and the second approval process with respect to the second identity domain are executed by a same service.

17. The non-transitory media of claim 1, wherein the first identity domain is associated with a cloud provider and the second identity domain is associated with a cloud reseller.

18. A method, comprising:
identifying a first entity that is authenticated with respect to a first identity domain;
executing a cross-domain approval process comprising a first approval process with respect to a second identity domain to approve access for the first entity authenticated with respect to the first identity domain, wherein the first identity domain and the second identity domain are different;
responsive at least to successfully completing the cross-domain approval process, granting, to the first entity, access to a target resource; and
wherein the method is performed by at least one device including a hardware processor.

19. The method of claim 18, wherein the first identity domain and the second identity domain comprise different identities, and wherein the first identity domain and the second identity domain are federated with different identity providers.

20. A system comprising:
at least one device including a hardware processor;
the system being configured to perform operations comprising:
identifying a first entity that is authenticated with respect to a first identity domain;
executing a cross-domain approval process comprising a first approval process with respect to a second identity domain to approve access for the first entity authenticated with respect to the first identity domain, wherein the first identity domain and the second identity domain are different;
responsive at least to successfully completing the cross-domain approval process, granting, to the first entity, access to a target resource.
